(19) United States
(12) Patent Application Publication
(10) Pub. No.: US 2007/0164108 A1
(43) Pub. Date: Jul. 19, 2007

(54) Calculator

(75) Inventors: Kan Tak Tam, Hongkong (CN); Shi Hua Zou, Hongkong (CN); Yuen Hon Lai, Hongkong (CN); Ka Kuen Au, Hong Kong (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Truly Electronics Manufacturing Limited, Hongkong (CN)

(21) Appl. No.: 11/428,932

(22) Filed: Jul. 6, 2006

(30) Foreign Application Priority Data
Oct. 13, 2005 (CN) 200510112667.1

(51) Int. Cl. G06F 3/08

(52) U.S. Cl. 235/419

(57) ABSTRACT

A foldable calculator comprising: (i) a main body having an upper cover with a rectangular recess on the outer surface of the upper cover, a lower cover; and a hinge joining the upper cover and the lower cover together, (ii) a display screen, (iii) a keyboard having a first key set (frequently used keys) with relatively large key pressing areas and a second key set (infrequently used keys) with relatively smaller key pressing areas, and (iv) a retractable support member, wherein the upper cover is openable at an angle from the lower cover suitable for a user to view the display screen when the retractable support member is open, and the retractable support member is retractable into the rectangular recess on the outer surface of the upper cover when the retractable support member is not in use.

### CROSS-REFERENCE TO RELATED APPLICATION

This application claims priority of Chinese Patent Application No. 2005 1011 2667.1, filed on Oct. 13, 2005, entitled “Calculator” by Kan Tak TAM, Shihua ZOU, Yuen Hon LAI, and Ka Kuen AU, the disclosure of which is incorporated herein by reference in its entirety.

### FIELD OF THE PRESENT INVENTION

The present invention relates to a foldable calculator, and more particularly, relates to a new structure and a new key layout method of a foldable calculator, the foldable calculator of the present invention is especially suitable for scientific calculators or calculators with many key mappings.

### BACKGROUND OF THE PRESENT INVENTION

A portable calculator, especially a scientific calculator has many keys, such as numerical keys, arithmetic keys, and function keys, and has very limited calculator surface to arrange the placement of these keys required by the functionalities of the calculator. Additionally, in order to be portable, the size of scientific calculator is usually pocket-size and the keys have to be made small. Adult users find it difficult to use such a calculator with small keys. It is common practice for an adult user to press wrong keys or press multiple keys at the same time.

In addition, the display of traditional pocket-size scientific calculator is hard for a user to see when the calculator is laid flat on a table. Its viewing angle is not suitable for the user to see the display clearly.

Therefore, a heretofore unaddressed need exists in the art to address the aforementioned deficiencies and inadequacies.

### SUMMARY OF THE PRESENT INVENTION

In one aspect, the present invention relates to a foldable calculator. In one embodiment, the foldable calculator comprises: (i) a main body, (ii) a display screen, (iii) a keyboard, and (iv) a retractable support member. The main body comprises: an upper cover having a first joining edge, an opposite second edge and a rectangular recess formed on the outer surface of the upper cover, a lower cover comprising a first joining edge, an opposite second edge, and a hinge joining the first joining edge of the upper cover and the first joining edge of the lower cover together. The display screen is formed on the inner surface of the upper cover. The keyboard comprises a first key set and a second key set. The first key set is formed on the inner surface of the lower cover and the second key set is formed on the inner surface of the upper cover. The retractable support member comprises (a) a first side where a shaft member is formed for mounting the retractable support member to the rectangular recess of the upper cover, and (b) a second side opposite to the first side having two foot pads, wherein the two foot pads are located on the same horizontal plane with the basal plane of the lower cover. The upper cover is openable at an angle from the lower cover suitable for a user to view the display screen when the retractable support member is open. The retractable support member is retractable into the rectangular recess on the outer surface of the upper cover when the retractable support member is not in use.

In one embodiment, the first key set is also known as frequently used key set and this key set comprises a set of keys including: (i) numerical keys “0-9”, (ii) a decimal point key “.”, (iii) arithmetic keys “+, −, ×, ÷”, (iv) a key for deleting “DEL”, a key for cancelling “AC”, and keys of “EXP, Ans, EXE”. The second key set is also known as infrequently used key set and this key set comprises a set of keys including: (i) a switch key for turning on and turning off power, (ii) function keys “SIN, COS, TAN”, (iii) a shift key “Shift”, (iv) a mode key “Mode”, (v) logarithmic keys “Log, Ln”, and (vi) a memory key “M+”.

In one embodiment, the hinge comprises: (i) two hinge pins, (ii) two outer mortise portions formed on each end of the first joining edge of the lower cover having a round opening in the center for installing the hinge pins, (iii) two inner mortise portions formed between the center and the end of the first joining edge of the upper cover having a round opening in the center for installing the hinge pins, (iv) a positioning axle, (v) a protrusion on the first joining edge of the upper cover, and (vi) a protrusion on the first joining edge of the lower cover. The two outer mortise portions and the inner mortise portions are joined by the two hinge pins to form one mortise hinge on each end of the first joining edge of the upper cover and the first joining edge of the lower cover. The positioning axle is installed in the center of the first joining edge to keep the outer mortise portions and inner mortise portion in place, and the protrusion of the upper cover and the protrusion of the lower cover hold the positioning axle in place.

In one embodiment, the positioning axle comprises: (i) two round pins formed on each end of positioning axle for insertion into the round openings of the inner mortise portions of the upper cover, (ii) a position limiting groove for receiving the protrusion on the first joining edge of the upper cover and the protrusion on the first joining edge of the lower cover to limit the movement of the positioning axle and opening of the upper cover and the lower cover, and a longitudinal opening through the positioning axle so that the wires or ribbon cable for connecting the circuits in the upper cover and the lower cover go through.

In one embodiment, the rectangular recess comprises: (i) a first side having two openings on each end for installing the shaft member of the retractable support member, wherein the first side wall is in an angle so that the retractable support member rests on the first side wall of the rectangular recess of the upper cover to position the upper cover in a suitable viewing angle, (ii) an opposite second side near the first joining edge of the upper cover having two recesses on each end for placing the foot pads of the retractable support member, (iii) a curved surface between the first side wall and bottom of the recess having a resilient support at the center of an opening, (iv) two protrusions located near each end of the second side wall for holding the retractable support member in place when the retractable support member is not in use, and (v) a recess for installing a battery for the foldable calculator. In another embodiment, the rectangular recess further comprises a notch for access to the retractable support member. In yet another embodiment, the upper cover further comprises a notch for access to the retractable support member.

In one embodiment, the upper cover further comprises a notch at the center of the second edge for opening of the upper cover and lower cover. The lower cover further comprises a notch at the center of the second edge for opening of the upper cover and lower cover.

In one embodiment, he retractable support member further comprises: (i) an oblique plane between the shaft member and the outer surface of the retractable support member so the oblique plane rests on the first side wall of the rectangular recess of the upper cover to position the upper cover in a suitable viewing angle, when the retractable support member 5 is fully opened, (ii) two recesses located near each end of the second side wall for receiving the protrusions, respectively, located near each end of the second side for holding the retractable support member in place when the retractable support is not in use, and (iii) a curved protrusion on the surface of the shaft member for locking up the retractable support member against the resilient support of the rectangular recess to prevent the retractable support member from collapsing when the retractable support member is fully opened and in use.

In one embodiment, the foldable calculator further comprising: (i) a locking protrusion mounted at the center of the second edge of the upper cover, and (ii) a locking opening at the center of the second edge of the lower cover. When the foldable calculator is not in use, the locking protrusion is inserted into the locking opening to secure the upper cover and the lower cover in a closed position.

In order to prevent the foldable calculator from freely moving when it is placed on a flat surface, a plurality of nonskid pads are attached to several locations such as: (i) near four corners of the outer surface of the lower cover, (ii) two sides of the joining edge of the upper cover, and (iii) two foot pads of the retractable support member.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a perspective view of a foldable calculator as it is used according to one embodiment of the present invention.

FIG. 2 is an exploded view of major components of a foldable calculator according to one embodiment of the present invention.

FIG. 3 shows the outer surface of a retractable support member removed from an upper cover of a foldable calculator, according to one embodiment of the present invention.

FIG. 4 shows the inner surface of a retractable support member removed from an upper cover of a foldable calculator, according to one embodiment of the present invention.

FIG. 5 is the structure view of an upper cover of a foldable calculator with a retractable support member removed, according to one embodiment of the present invention.

FIG. 6 is an enlarged view of portion A of an upper cover of a foldable calculator shown in FIG. 5, according one embodiment of the present invention.

FIG. 7 is a partial sectional view of a joint of a retractable support member and an upper cover as the retractable support member is swing open and in position to support the upper cover, according to one embodiment of the present invention.

FIG. 8 is a perspective structure view of the face plate of an upper cover according one embodiment of the present invention.

FIG. 9 is a perspective structure view of the face plate of a lower cover according one embodiment of the present invention.

FIG. 10 is a perspective view of a positioning axle according to one embodiment of the present invention.

FIG. 11 is an exemplary key layout of a foldable calculator, viewing from the top when the upper cover is fully opened, in accordance with exemplary aspect of the present invention.

FIG. 12 is a bottom view of a foldable calculator, when the upper cover is fully opened, in accordance with exemplary aspect of the present invention.

FIG. 13 is a side view of a foldable calculator, when the upper cover is opened and the retractable support member is in use, according to one embodiment of the present invention.

FIG. 14 is a perspective view of a foldable calculator when it is not in use and the retractable support member is stowed in the rectangular recess of the upper cover in accordance with exemplary aspect of the present invention.

### DETAILED DESCRIPTION OF THE PRESENT INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

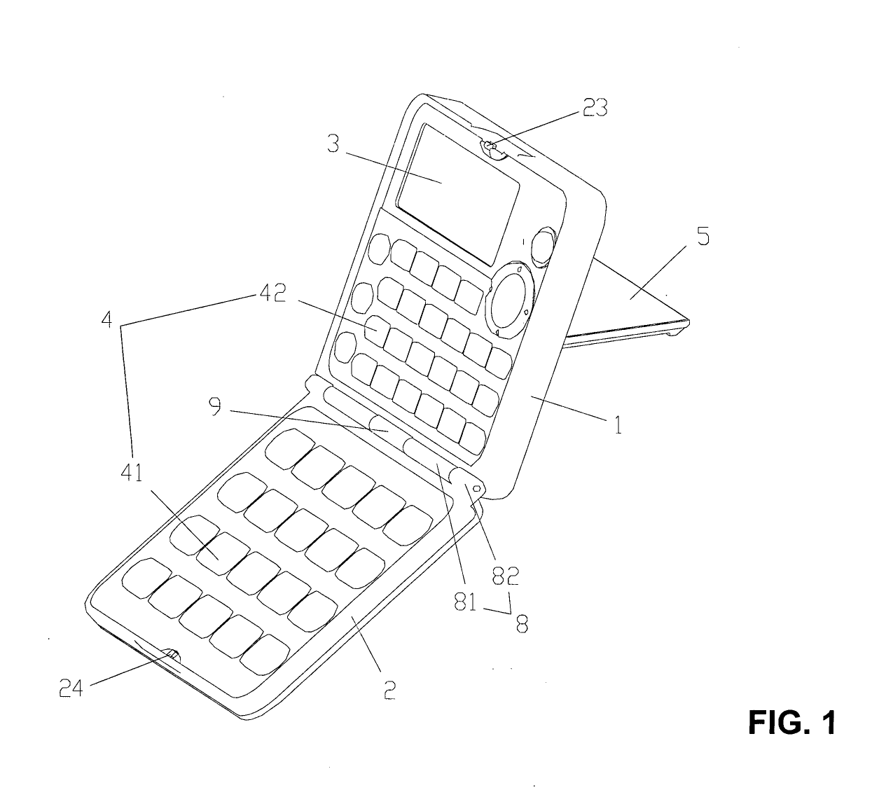

The description will be made as to the embodiments of the present invention in conjunction with the reference to the accompanying drawings in FIGS. 1-14. In accordance with the purposes of this invention, as embodied and broadly described herein, this invention, in one aspect, relates to a foldable calculator.

Referring now to FIG. 1, a perspective view of a foldable calculator as it is used is shown according to one embodiment of the present invention. The foldable calculator comprises:
(i) a main body,
(ii) a display screen 3,
(iii) a keyboard 4, and
(iv) a retractable support member 5.

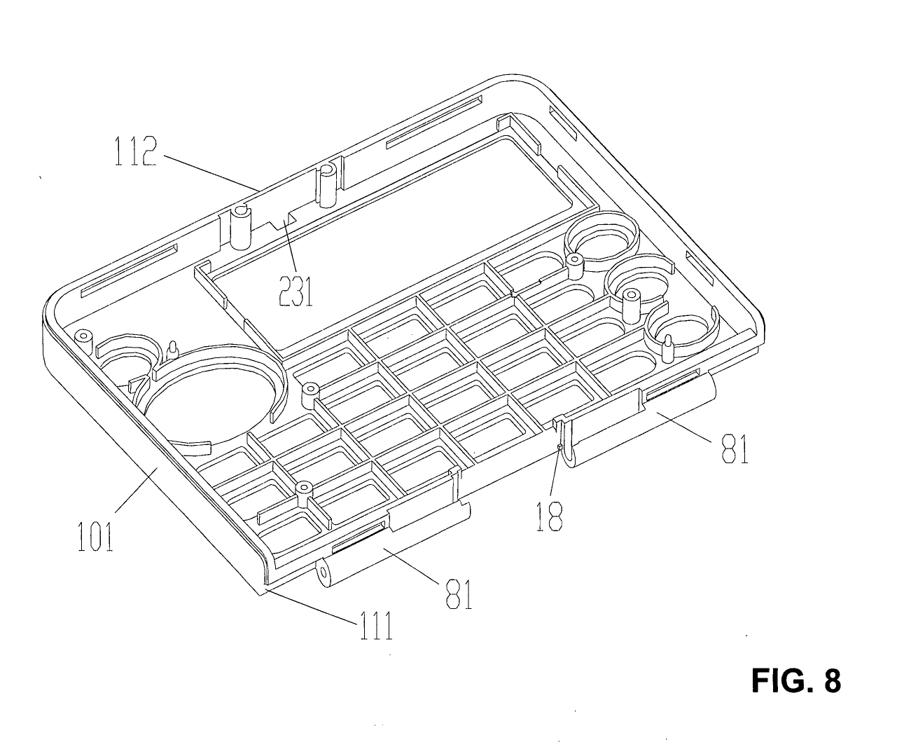

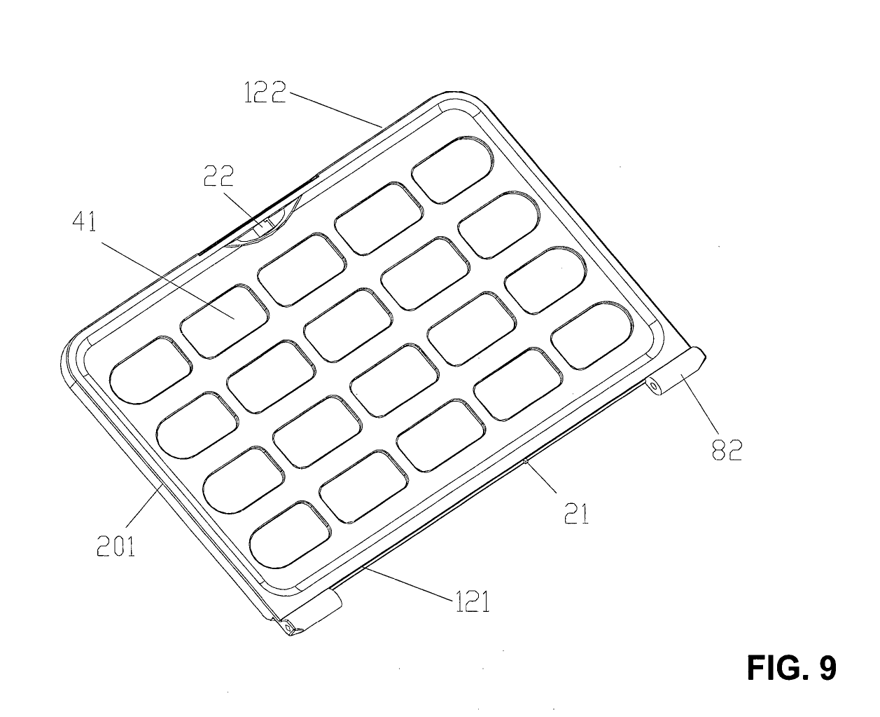

The main body of the foldable calculator comprises:
(i) an upper cover 1 comprising a first joining edge 111 (not marked in FIG. 1, see FIG. 8 for detail), an opposite second edge 112 (not marked in FIG. 1, see FIG. 8 for detail) and a rectangular recess 13 formed on the outer surface of the upper cover 1; and
(ii) a lower cover 2 comprising a first joining edge 121 (not marked in FIG. 1, see FIG. 9 for detail), an opposite second edge 122 (not marked in FIG. 1, see FIG. 9 for detail).
(iii) a hinge 8 joining the first joining edge 111 of the upper cover 1 and the first joining edge 121 of the lower cover 2 together.

The keyboard 4 is divided into two key sets: (i) a first key set 41, and (ii) a second key set 42. In one embodiment, the first key set 41 is also known as a frequently used key set since it contains the key set most frequently used by a user. The second key set 42 is also known as an infrequently used key set since the keys in this key set are less frequently used by a user comparing to the keys in the first key set 41. In one embodiment, the first key set 41 comprises: numerical keys “0-9”, a decimal point key “.”, arithmetic keys “+, −, ×, ÷”, a key for deleting “DEL”, a key for cancelling “AC”, and keys of “EXP, Ans, EXE”, and the second key set 42 comprises: a switch key for turning on and off the power to the foldable calculator, function keys “SIN, COS, TAN”, a shift key “Shift”, a mode key “Mode”, logarithmic keys “Log, Ln”, and a memory key “M+”. This is only an exemplary layout of the keys used in this embodiment. The distribution of the first key set 41 and second key set 42 is defined according the design and functionalities of the foldable calculator.

According to the embodiment shown in FIG. 1, the display screen 3 is mounted on the upper left corner of the inner surface of the upper cover 1. The second key set 42 is laid-out to the right and below the display screen 3. The frequently used key set 41 is laid-out on the inner surface of the lower cover 2.

When the foldable calculator is in use, the upper cover 1 is opened up to an angle from the lower cover 2 suitable for a user to view the display screen 3 when the retractable support member 5 is opened, and the retractable support member 5 is stowed into the rectangular recess 13 on the outer surface of the upper cover 1 when the retractable support member 5 is not in use.

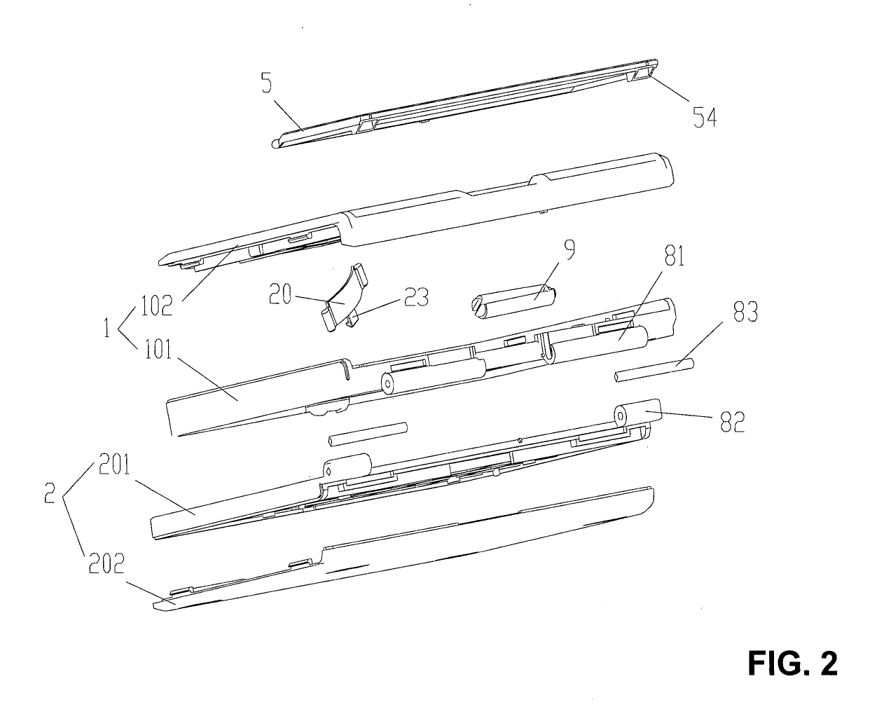

Referring now to FIG. 2, an exploded view of major components of a foldable calculator is presented according to one embodiment of the present invention. The hinge 8 comprises:
(i) two hinge pins 83;
(ii) two outer mortise portions 82 formed on each end of the first joining edge 121 of the lower cover 2 having a round opening in the center for installing the hinge pins 83;
(iii) two inner mortise portions 81 formed between the center and the end of the first joining edge 111 of the upper cover 1 having a round opening in the center for installing the hinge pins 83;
(iv) a positioning axle 9;
(v) a first protrusion 18 on the first joining edge of the upper cover 1 for positioning purpose;
(vi) a second protrusion 21 on the first joining edge of the lower cover 2 for positioning purpose; and
(vii) a buckle 20 with a locking protrusion 23.

When the hinge 8 is in operation, the two outer mortise portions 82 and the inner mortise portions 81 are joined by the hinge pins 83 to form one mortise hinge 8 on each end of the first joining edge 111 of the upper cover 1 and the first joining edge 121 of the lower cover 2. The positioning axle 9 is installed in the space between two inner mortise portions 81 at the center of the first joining edge 111 of the upper cover 1 and the first joining edge 121 of the lower cover 2 to keep the outer mortise portions 82 and the inner mortise portion 81 in place. The first protrusion 18 of the upper cover 1 and the second protrusion 21 of the lower cover 2 hold the positioning axle 9 in place.

The upper cover 1 further comprises an outer cover portion 102 and an inner cover portion 101. The lower cover 2 further comprises an outer cover portion 202 and an inner cover portion 201. In one embodiment, the outer cover portions 102 and the inner cover portion of 101 of the upper cover 1, and the outer cover portions 201 and the inner cover portion of 202 of the lower cover 2 are joined by a plurality of interlocking pins. In another embodiment, the outer cover portions 102 and the inner cover portion of 101 of the upper cover 1, and the inner cover portion of 202 of the lower cover 2 are joined by a plurality of screws. Other permanent or temporary joining means can also be used. Then the upper cover 1 and the lower cover 2 are joined together with a hinge 8 on the first joining edge 111 of the upper cover 1 and the first joining edge 121 of the lower cover 2.

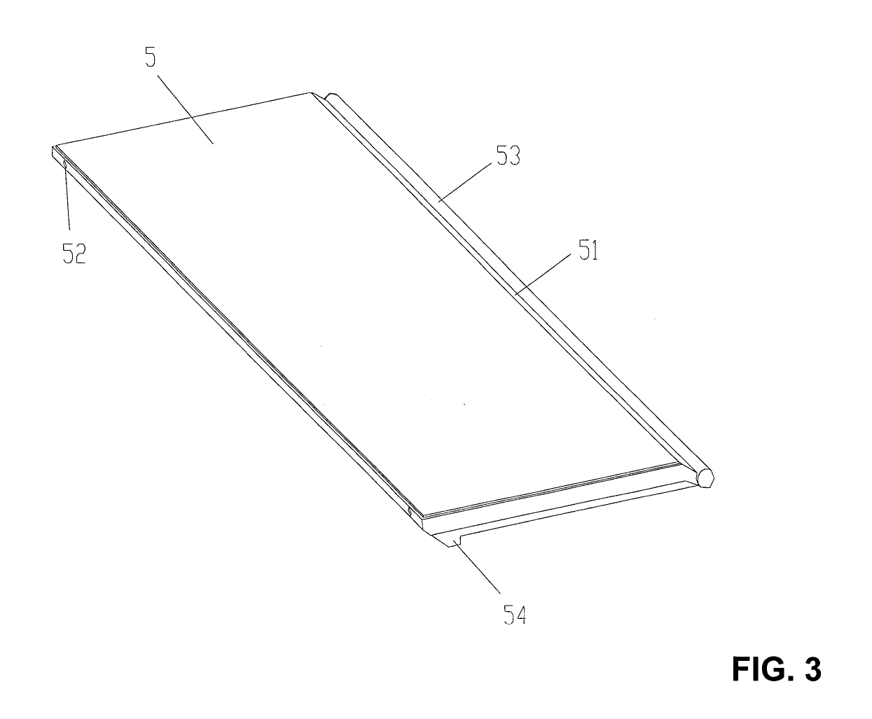

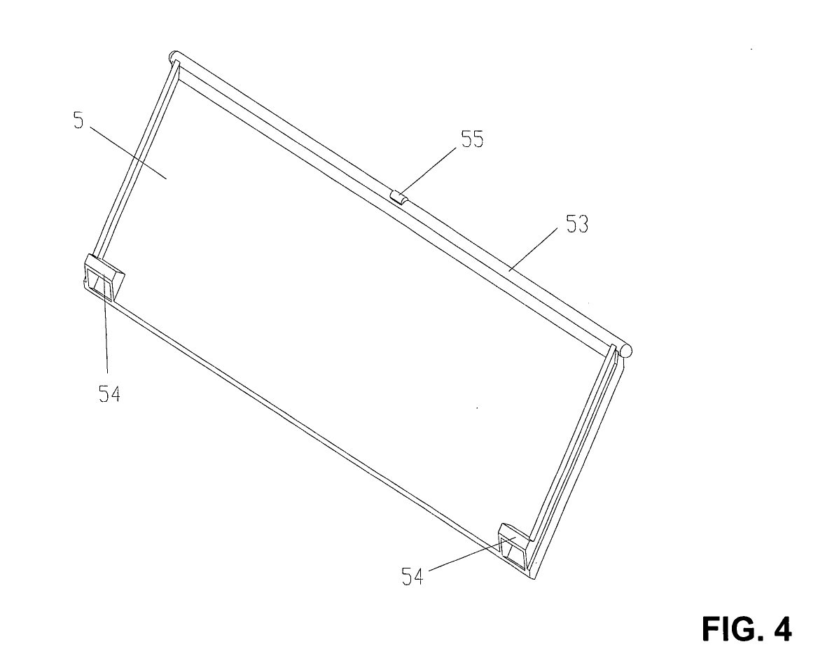

Referring now to FIGS. 3 and 4, a retractable support member 5 is shown from two opposite angles, according one embodiment of the present invention. The retractable support member 5 comprises:
(i) a first side wall where a shaft member 53 is formed for mounting the retractable support member 5 to the rectangular recess 13 of the upper cover 1, and used as an axel for the opening and closing of the retractable support member 5;
(ii) a second side wall opposite to the first side wall having two foot pads 54, wherein the bottom surface of the two foot pads 54 are located on the same horizontal plane with the basal plane of the lower cover 2,
(iii) an oblique plane 51 between the shaft member 53 and the outer surface of the retractable support member 5 so the oblique plane 51 rests on a first side wall 11 of the rectangular recess 13 of the upper cover 1 to position the upper cover 1 in a suitable viewing angle, when the retractable support member 5 is fully opened;
(iv) two recesses 52 located near each end of the second side wall opposite to the first side wall for receiving two protrusions 12, respectively, located near each end of the second side wall for holding the retractable support member 5 in place when the retractable support is not in use; and
(v) a curved protrusion 55 on the surface of the shaft member 53 for locking up the retractable support member 5 against a resilient support 17 of the rectangular recess 13 to prevent the retractable support member 5 from collapsing when the retractable support member 5 is fully opened and in use.

The upper cover 1 is openable at an angle from the lower cover 2 suitable for a user to view the display screen 3 when the retractable support member 5 is fully opened and in use. The retractable support member 5 is stowed into the rectangular recess 13 on the outer surface of the upper cover 1 when the retractable support member 5 is not in use.

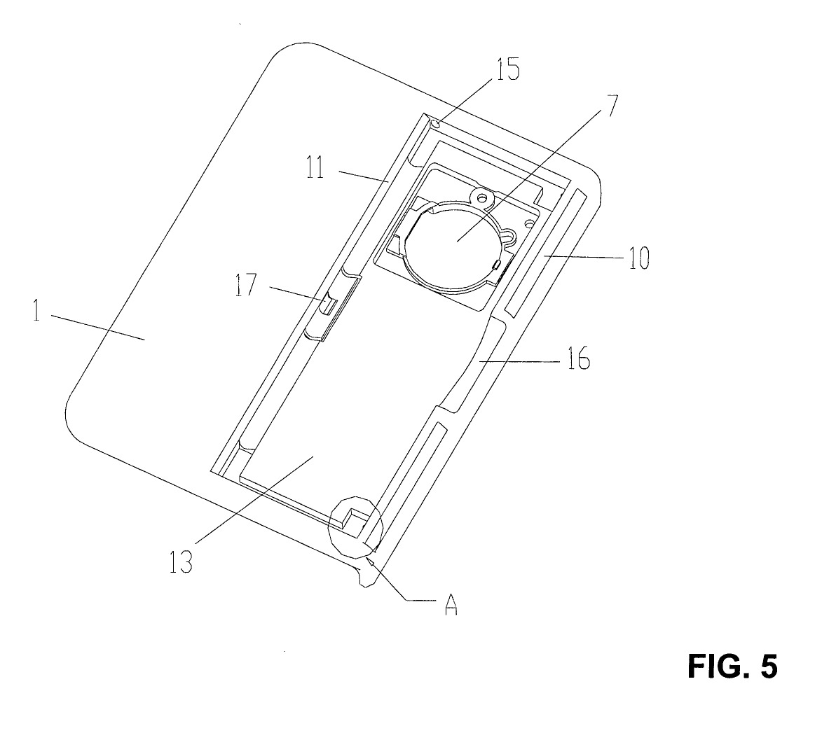

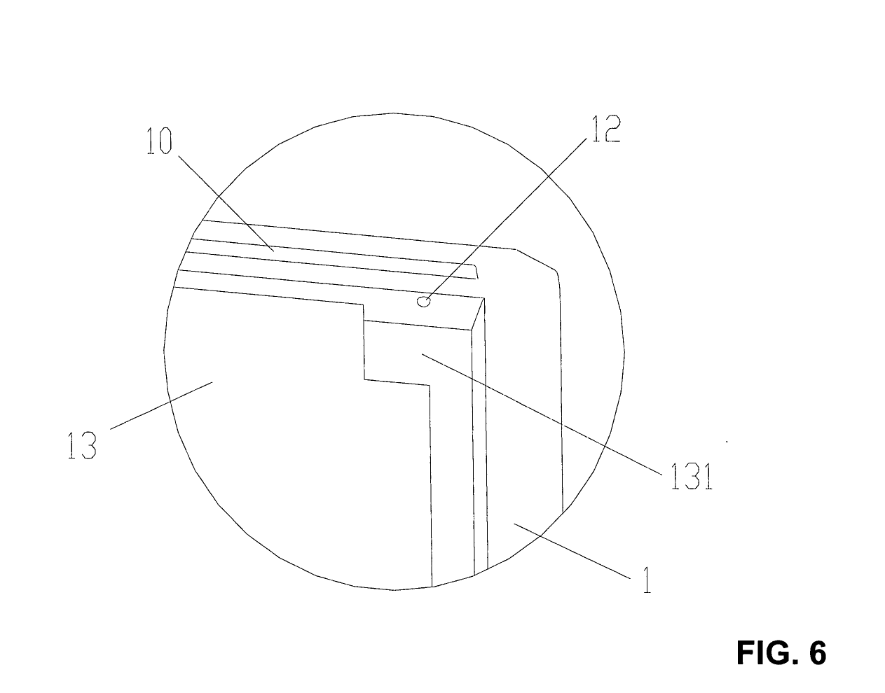

Referring now to FIGS. 5 and 6, a perspective structure view of an upper cover of a foldable calculator with the retractable support member 5 removed, and an enlarged view of portion A of an upper cover of a foldable calculator are shown, according to one embodiment of the present invention. The rectangular recess 13 comprises:
(i) a first side wall 11 having two openings 15 on each end for installing the shaft member 53 of the retractable support member 5, wherein the first side wall 11 is in an angle so that the retractable support member 5 rests on the first side wall 11 of the rectangular recess 13 of the upper cover 1 to position the upper cover 1 in a suitable viewing angle, when the retractable support member 5 is fully opened and in use;
(ii) an opposite second side wall near the first joining edge 111 of the upper cover 1 having two recesses 131 on each end for receiving the two foot pads 54 of the retractable support member 5;
(iii) a curved surface between the first side wall 11 and bottom of the recess having a resilient support 17 at the center of an opening; and
(iv) two protrusions 12 located near each end of the second side wall for holding the retractable support member 5 in place when the retractable support member 5 is not in use.

The rectangular recess 13 further comprises (i) a recess 7 for installing a battery for the foldable calculator, and (ii) a notch 16 for access to the retractable support member 5.

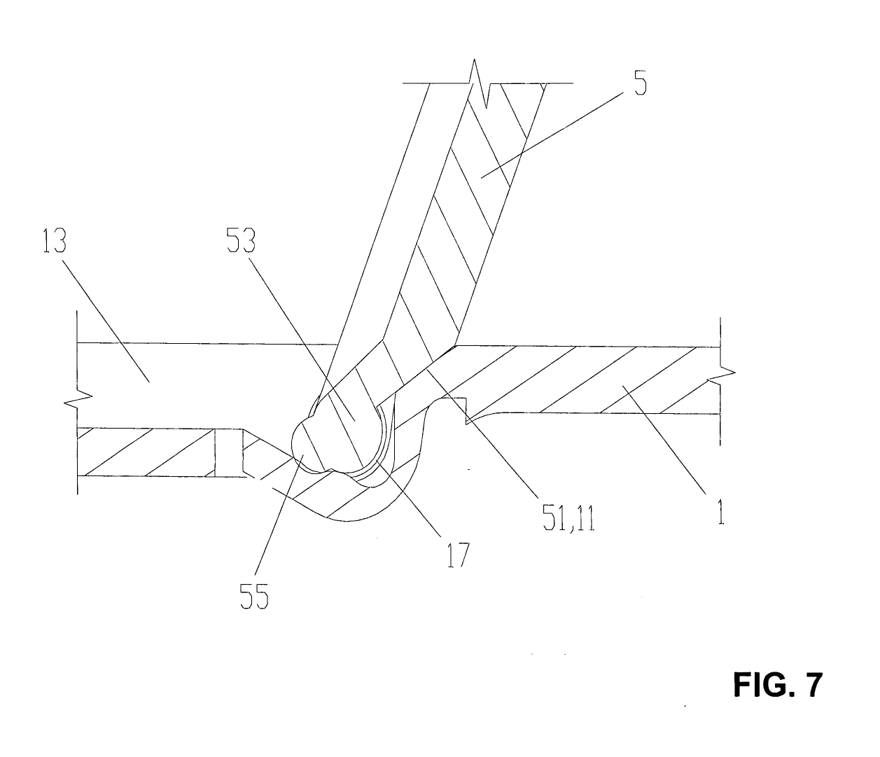

Referring now to FIG. 7, a partial sectional view of a joint of the retractable support member 5 and an upper cover as the retractable support member is swing open and in position to support the upper cover 1 is shown, according to one embodiment of the present invention. When the retractable support member 5 is in use, it is fully opened until the oblique plane 51 of the retractable support member 5 rests on the first side wall 11. At this time, the resilient support 17 engages the shaft member 53 and the protrusion 55 on the shaft member 53 of the retractable support member 5 and prevents the retractable support member 5 from moving and forms a suitable viewing angle of the upper cover 1 from the lower cover 2. When the retractable support member 5 is not in use, the retractable support member 5 is stowed away into the rectangular recess 13. The outer surface of the retractable support member 5 is flush with the outer surface of the upper cover 1. In this position, the resilient support 17 engages with the shaft member 53 and the protrusion 55 on the shaft member 53 of the retractable support member 5 and prevents the retractable support member 5 from moving and hold the retractable support member 5 in place, along with the two protrusions 12 shown in FIG. 6.

Referring now to FIG. 8, a perspective structure view of the inner portion 101 of the upper cover 1 is shown, according one embodiment of the present invention. The inner portion 101 of the upper cover 1 comprises: (i) a first joining edge 111, (ii) a second edge 112, (iii) two inner mortise portions 81 of the upper cover 1, (iv) a first protrusion 18, and (v) a plurality of openings for keys, display screen, and switch. The inner portion 101 of the upper cover 1 further comprises an opening 231 for installing a locking protrusion 23. The buckle 20 (shown in FIG. 2) of the upper cover 1 is mounted in the opening 231 of the inner portion 101 of the upper cover 1. A locking protrusion 23 is formed at the lower portion of the buckle 20, which conjugates with the opening 22 (shown in FIG. 9) near the second edge 122 of the lower cover 2 to achieve the clip locking of the upper cover 1 and the lower cover 2 when they are closed.

FIG. 9 is a perspective structure view of the inner portion 201 of the lower cover 2, according one embodiment of the present invention. The inner portion 201 of the lower cover 2 comprises: (i) a first joining edge 121, (ii) a second edge 122, (iii) two outer mortise portions 82 of the lower cover 2, (iv) a second protrusion 21, and (v) a plurality of openings for keys 41. The inner portion 201 of the lower cover 2 further comprises a locking opening for receiving the locking protrusion 23 and locking up the upper cover 1 to the lower cover 2 when the foldable calculator is closed.

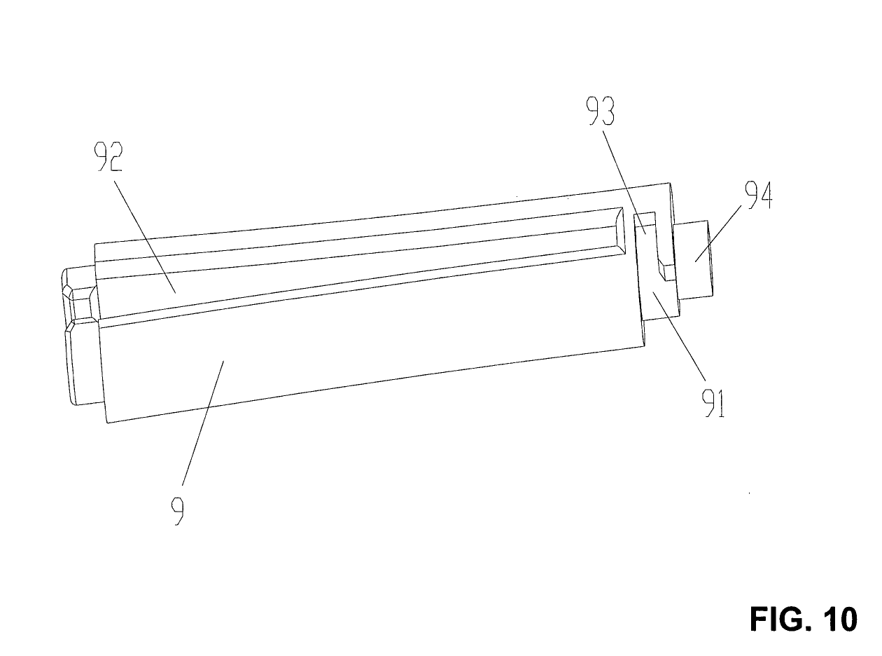

Referring now to FIG. 10, a perspective view of a positioning axle 9 is shown, according to one embodiment of the present invention. The positioning axle 9 comprises:
(i) two round pins 94 formed on each end of positioning axle 9 for insertion into the round openings of the inner mortise portions 81 of the upper cover 1;
(ii) a first position limiting groove 91 for receiving the first protrusion 18 on the first joining edge of the upper cover 1 and the second protrusion 21 on the first joining edge of the lower cover 2 to limit the movement of the positioning axle 9 and opening of the upper cover 1 and the lower cover 2; and
(iii) a longitudinal opening 92 through the positioning axle 9 so that the wires or ribbon cable for connecting the circuits in the upper cover 1 and the lower cover 2 go through.

When the upper cover 1 and the lower cover 2 are joined with two hinge pins 83, the positioning axle 9 is installed in the space between the two inner mortise portions 81 of the upper cover 1 at the center of the first joining edge 111 of the upper cover 1. Connection wires or ribbon cables are installed through the longitudinal opening 92 to connect the circuit installed inside the upper cover 1 and the circuit installed inside the lower cover 2.

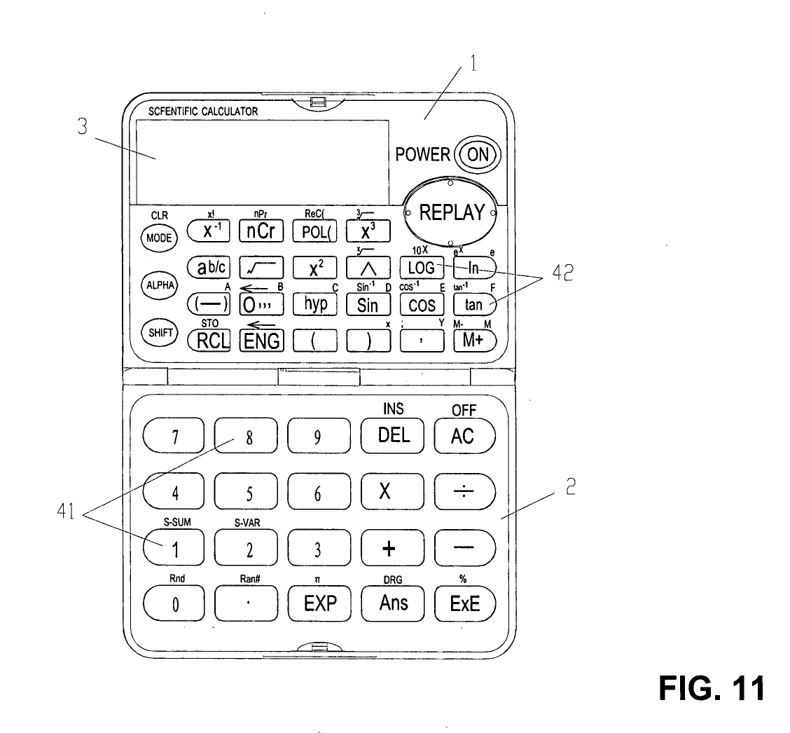

FIG. 11 is an exemplary key layout of a foldable scientific calculator, viewing from the top when the upper cover is fully opened, in accordance with exemplary aspect of the present invention. The upper cover 1 comprises a display screen, a power on/off button, a replay button, and a plurality of the keys including a second key set 42, or the infrequently used key set. The lower cover 2 comprises a plurality of the keys including a first key set 41, or the frequently used key set. In order to reduce the possibility of pressing the incorrect button, the frequently used key set 41 is designed to be larger than the infrequently user key set 42. Based on different designs and required functionalities of calculators, the keys to be included in the first key set 41 and the second key set 42, and the sizes of these two key sets are adjustable.

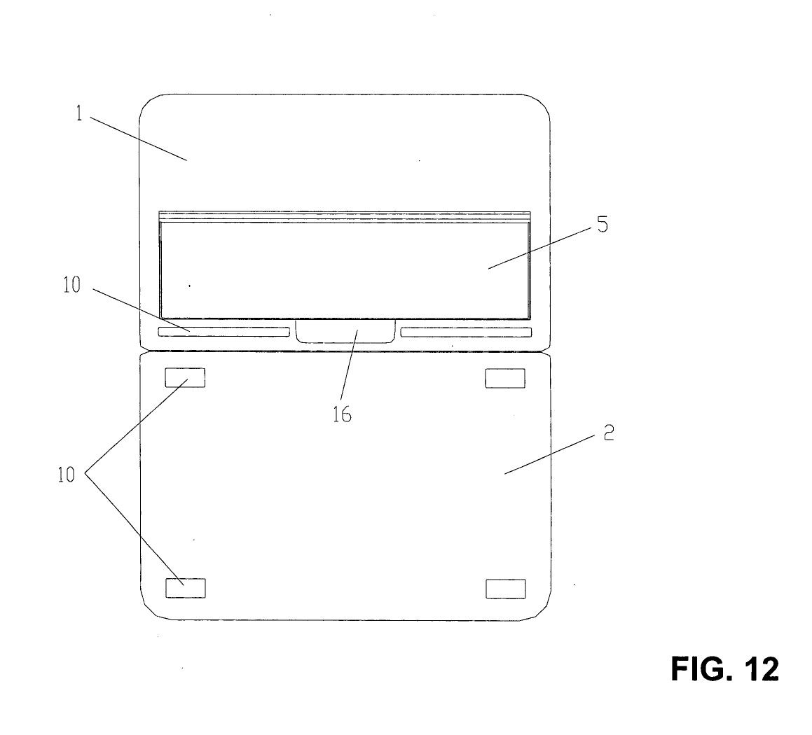

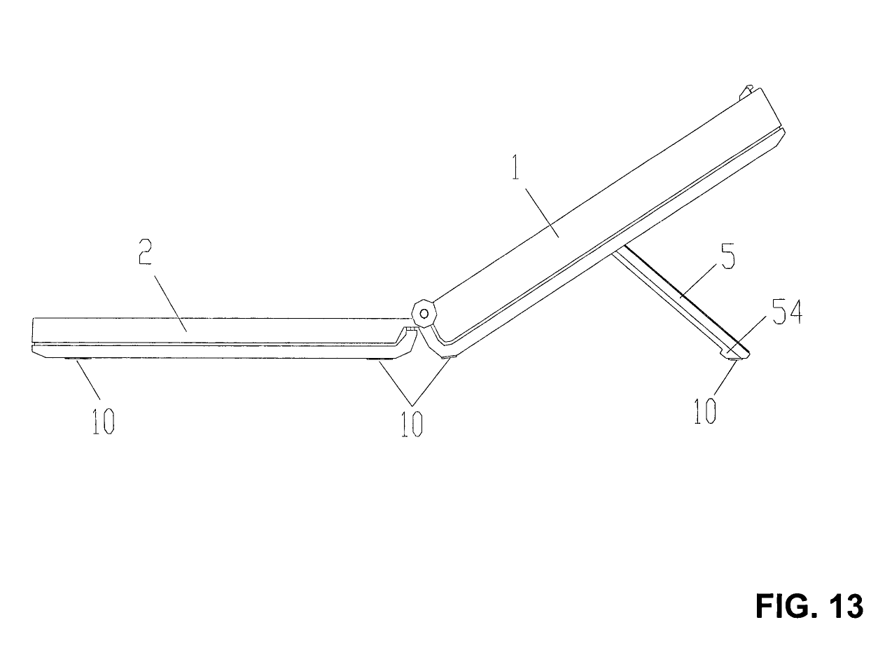

FIG. 12 is a bottom view of a foldable calculator, when the upper cover is fully opened and the retractable support member 5 is not in use and stowed away in the rectangular recess 13, in accordance with exemplary aspect of the present invention. The upper cover 1 further comprises a notch 16 for a user to open the retractable support member 5. A plurality of the nonskid pads 10 in various shapes are attached at:
(i) the four corners of the outer surface of the lower cover 2;
(ii) the two sides of the joining edge 111 of the upper cover 1; and
(iii) the bottom surface of the two foot pads 54 of the retractable support member 5 (not shown in FIG. 12, see FIGS. 4 and 13 for details).

FIG. 13 is a side view of a foldable calculator, when the upper cover is opened and the retractable support member is in use to form a suitable viewing angle for a user, according to one embodiment of the present invention. In this position, the outer surface of the lower cover 2, and portion where two nonskid pads 10 are attached, and the surface of the two foot pads 54 of the retractable support member 5 are in the same plane and the nonskid pads 10 prevent the foldable calculator from moving.

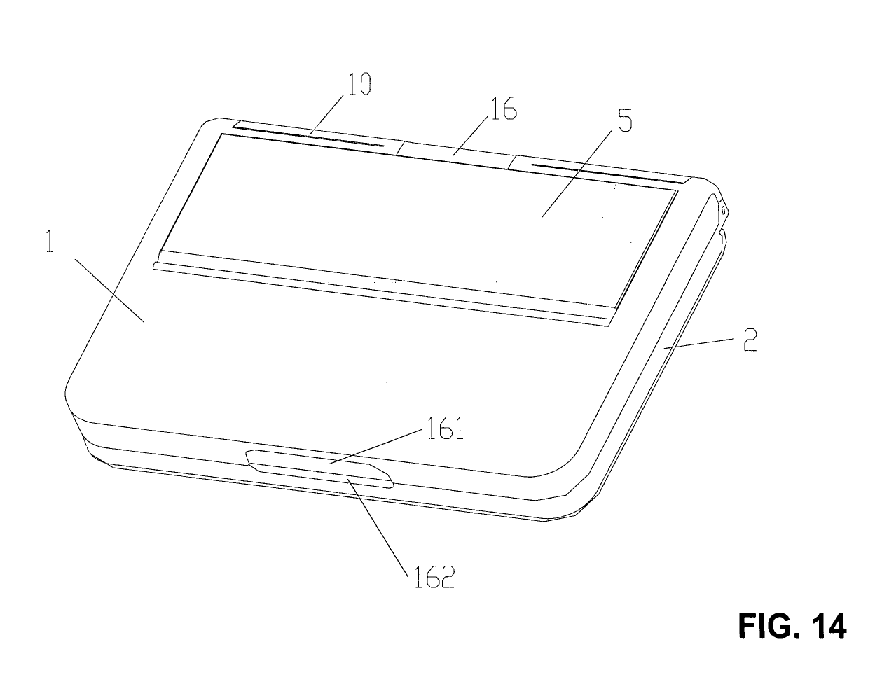

FIG. 14 is a perspective view of a foldable calculator when it is not in use and the retractable support member is stowed in the rectangular recess of the upper cover in accordance with exemplary aspect of the present invention. The upper cover 1 further comprises a notch 161 in the center of the second edge 112 of the upper cover 1. The lower cover 2 further comprises a notch 162 in the center of the second edge 122 of the lower cover 2. These two notches are used to open the upper cover 1 and lower cover 2.

One of the advantages of the foldable calculator of the present invention is that the keyboard 4 is divided into a first key set (also known as frequently used key set) 41 and a second key set (also known as infrequently used key set) 42. The stroke area of the frequently used key set 41 is made relatively larger and the keys for this key set are located on the inner surface of the lower cover 2 such that it is easy to press the keys. The stroke area of infrequently used key set 42 is made relatively smaller and the key sets along with the display screen are located on the inner surface of the upper cover 1.

The second improvement of the present invention is that on the outer surface of the upper cover 1, a retractable support member 5 is provided. When the retractable support member 5 is fully opened and in use, the upper cover 1 is openable at an angle from the lower cover 2 suitable for a user to view the display screen 3. Two foot pads 54 of the retractable support member 5 are located on the same horizontal plane with the basal plane of the lower cover 2 (shown as FIG. 13). When the retractable support member 5 is closed and stowed away into a rectangular recess 13, the foldable calculator is laid flat on the table.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A foldable calculator, comprising:
(i) a main body having
(a) an upper cover comprising a first joining edge, an opposite second edge and a rectangular recess formed on the outer surface of the upper cover;
(b) a lower cover comprising a first joining edge, an opposite second edge; and
(c) a hinge joining the first joining edge of the upper cover and the first joining edge of the lower cover together;
(ii) a display screen formed on the inner surface of the upper cover;
(iii) a keyboard having a first key set and a second key set, wherein the first key set is formed on the inner surface of the lower cover and the second key set is formed on the inner surface of the upper cover; and
(iv) a retractable support member having
(a) a first side where a shaft member is formed for mounting the retractable support member to the rectangular recess of the upper cover; and
(b) a second side opposite to the first side having two foot pads, wherein the two foot pads are located on the same horizontal plane with the basal plane of the lower cover,
wherein the upper cover is openable at an angle from the lower cover suitable for a user to view the display screen when the retractable support member is open, and the retractable support member is retractable into the rectangular recess on the outer surface of the upper cover when the retractable support member is not in use.

2. The foldable calculator of claim 1, wherein the first key set comprises a set of keys including:
(i) numerical keys “0-9”;
(ii) a decimal point key “.”;
(iii) arithmetic keys “+, −, ×, ÷”;
(iv) a key for deleting “DEL”;
(v) a key for cancelling “AC”; and
(vi) keys of “EXP, Ans, EXE”.

3. The foldable calculator of claim 1, wherein the infrequently used key set comprises a set of keys including:
(i) a switch key for turning on and turning off power;
(ii) function keys “SIN, COS, TAN”;
(iii) a shift key “Shift”;
(iv) a mode key “Mode”;
(v) logarithmic keys “Log, Ln”; and
(vi) a memory key “M+”.

4. The foldable calculator of claim 1, wherein the hinge comprises:
(i) two hinge pins;
(ii) two outer mortise portions formed on each end of the first joining edge of the lower cover having a round opening in the center for installing the hinge pins;
(iii) two inner mortise portions formed between the center and the end of the first joining edge of the upper cover having a round opening in the center for installing the hinge pins;
(iv) a positioning axle;
(v) a first protrusion on the first joining edge of the upper cover; and
(vi) a second protrusion on the first joining edge of the lower cover,
wherein in operation, the two outer mortise portions and the inner mortise portions are joined by the hinge pins to form one mortise hinge on each end of the first joining edge, the positioning axle is installed in the space between the two inner mortise portions of the upper cover at the center of the first joining edge to keep the outer mortise portions and inner mortise portion in place, and the first protrusion of the upper cover and the second protrusion of the lower cover hold the positioning axle in place.

5. The foldable calculator of claim 4, wherein the positioning axle comprises:
(i) two round pins formed on each end of positioning axle for insertion into the round openings of the inner mortise portions of the upper cover;
(ii) a position limiting groove for receiving the first protrusion on the first joining edge of the upper cover and the second protrusion on the first joining edge of the lower cover to limit the movement of the positioning axle and opening of the upper cover and the lower cover; and
(iii) a longitudinal opening through the positioning axle so that the wires or ribbon cables for connecting the circuits in the upper cover and the lower cover go through.

6. The foldable calculator of claim 1, wherein the rectangular recess comprises:
(i) a first side having two openings on each end for installing the shaft member of the retractable support member, wherein the first side wall is in an angle so that the retractable support member rests on the first side wall of the rectangular recess of the upper cover to position the upper cover in a suitable viewing angle;
(ii) an opposite second side near the first joining edge of the upper cover having two recesses on each end for placing the foot pads of the retractable support member;
(iii) a curved surface between the first side wall and bottom of the recess having a resilient support at the center of an opening; and
(iv) two protrusions located near each end of the second side wall for holding the retractable support member in place when the retractable support member is not in use.

7. The foldable calculator of claim 6, wherein the retractable support member further comprises:
(i) an oblique plane between the shaft member and the outer surface of the retractable support member so the oblique plane rests on the first side wall of the rectangular recess of the upper cover to position the upper cover in a suitable viewing angle, when the retractable support member is fully opened;
(ii) two recesses located near each end of the second side wall for receiving the protrusions, respectively, located near each end of the second side for holding the retractable support member in place when the retractable support is not in use; and
(iii) a curved protrusion on the surface of the shaft member for locking up the retractable support member against the resilient support of the rectangular recess to prevent the retractable support member from collapsing when the retractable support member is fully opened and in use.

8. The foldable calculator of claim 1, further comprising a plurality of nonskid pads attached to:
(i) four corners of the outer surface of the lower cover;
(ii) two sides of the joining edge of the upper cover; and
(iii) the bottom surface of the two foot pads of the retractable support member.

9. The foldable calculator of claim 1, wherein the rectangular recess further comprises a recess for installing a battery for the foldable calculator.

10. The foldable calculator of claim 1, wherein the rectangular recess further comprises a notch for access to the retractable support member.

11. The foldable calculator of claim 1, wherein the upper cover further comprises a notch for access to the retractable support member.

12. The foldable calculator of claim 1, wherein the upper cover further comprises a notch at the center of the second edge for opening of the upper cover and lower cover.

13. The foldable calculator of claim 1, wherein the lower cover further comprises a notch at the center of the second edge for opening of the upper cover and lower cover.

14. The foldable calculator of claim 1, further comprising:
(i) a locking protrusion at the center of the second edge of the upper cover; and
(ii) a locking opening at the center of the second edge of the lower cover,
wherein in operation, the locking protrusion is inserted into the locking opening to lock the upper cover to the lower cover when the foldable calculator is not in use.
